(19) United States
(12) Patent Application Publication
(10) Pub. No.: US 2026/0291226 A1
(43) Pub. Date: Sep. 24, 2026

(54) SYSTEMS AND METHODS FOR CONFIGURING INVERTER-BASED RESOURCES

(71) Applicant: Florida Power & Light Company, Juno Beach, FL (US)

(72) Inventor: Joseph M. Arthur, II, Royal Palm Beach, FL (US)

(21) Appl. No.: 19/087,268

(22) Filed: Mar. 21, 2025

(51) Int. Cl. H02J 3/00; H02J 3/38

(52) U.S. Cl. CPC H02J 3/001; H02J 3/381

(57) ABSTRACT

The disclosed technology includes systems and methods for configuring inverter-based resources to mitigate high-risk conditions. An example method of the disclosed technology can include monitoring a plurality of sites within an electric grid. The method can further include identifying a first site of the plurality of sites to be associated with a high-risk condition. The method can further include determining at least a first portion of inverters to change a current operating mode from one of a Grid-Following (GFL) mode and a Grid-Forming (GFM) mode to the other of the GFL mode and the GFM mode. The method can further include outputting a signal to cause at least the first portion of inverters to change from the one of the GFL mode and the GFM mode to the other of the GFL mode and the GFM mode.

### FIELD OF THE DISCLOSURE

The various embodiments of the present disclosure relate generally to systems and methods of mitigating high-risk conditions for an electric grid, and more particularly to configuring inverter-based resources to mitigate high-risk conditions for an electric grid.

### BACKGROUND

Within an electric grid, electric power is generated in direct current (DC) from some power generation sites. For example, solar arrays and battery storage systems can produce DC power. For the electricity to be usable in the electric grid, the electric grid can include inverters to convert DC power into alternating current (AC) power. Traditionally, generators, or turbines, for fuel-based electricity generation have physical inertia to provide stability to the electricity generation. The physical inertia allows traditional generators to resist sudden changes in the flow of electricity in the electric grid, such as faults or load spikes. Inverters, however, do not have inherent stability from a physical inertia, and therefore can be augmented to replicate inertia-like properties to provide stability to the electric grid. Further, recent developments in electricity generation, such as a move towards renewable energy projects, has caused the stability of inverter-based resources to become a critical issue for the energy industry.

To resolve the stability issue, inverters can have different modes with characteristics for power conversion. For example, many inverters have a grid-following (GFL) mode, which depends on the electric grid for stability. GFL mode inverters allow power generation sites to operate at maximum capacity while being in compliance with electric grid and grid operator regulations. In GFL mode, the inverter uses the electric current as a reference, and injects current into the electric grid based on measured voltage levels. This causes GFL mode inverters to be susceptible to faults or load spikes as previously discussed. As a result, grid-forming (GFM) mode was developed, which produces an interval voltage as a reference. That is, inverters in GFM mode can be configured to inject voltage instantaneously based on changes in voltage levels in the electric grid. Consequently, GFM mode inverters often operate below maximum capacity, which can reduce rating and real power generation.

Accordingly, there is a need for improved systems and methods of configuring inverter-based resources to optimize real power generation while providing stability to the grid to minimize high-risk conditions such as faults or load spikes.

### BRIEF SUMMARY

An exemplary embodiment of the present disclosure provides a method for mitigating high-risk conditions for an electric grid. The method can include monitoring a plurality of sites within an electric grid. The method can include identifying a first site of the plurality of sites to be associated with a high-risk condition. The method can include determining a first portion of inverters of the first site to change a current operating mode from one of a Grid-Following (GFL) mode and a Grid-Forming (GFM) mode to the other of the GFL mode and the GFM mode. The method can include outputting a signal to cause the first portion of inverters to change from the one of the GFL mode and the GFM mode of the other of the GFL mode and the GFM mode.

In any of the embodiments disclosed herein, the method can further include receiving the signal at a controller. The method can further include changing, via the controller, the current operating mode for the first portion of inverters of the first site.

In any of the embodiments disclosed herein, determining the first portion of inverters of the first site to change the current operating mode can include determining the first portion of inverters to change the current operating mode from GFL mode to GFM mode.

In any of the embodiments disclosed herein, the method can further include determining, after outputting the signal, whether the first site is still associated with the high-risk condition.

In any of the embodiments disclosed herein, the method can further include determining, if the first site is not still associated with the high-risk condition, a second portion of inverters of the first site to change a current operating mode from GFM mode to GFL mode.

In any of the embodiments disclosed herein, monitoring the plurality of sites within the electric grid can include monitoring a number of generators in service within the electric grid. Monitoring the plurality of sites within the electric grid can further include monitoring a total generation from inverter-based resources within the electric grid.

In any of the embodiments disclosed herein, identifying the first site in the plurality of sites to be associated with a high-risk condition can be based at least in part on a risk score of the number of generators in service within the electric grid to the total generation from inverter-based resources within the electric grid.

An exemplary embodiment of the present disclosure provides a system. The system can include one or more processors and memory, storing instructions that when executed by the one or more processors can cause the one or more processors to monitor a plurality of sites within an electric grid; identify a first site in the plurality of sites to be associated with a high-risk condition; determine a first portion of inverters of the first site to change a current operating mode from one of a Grid-Following (GFL) mode and Grid-Forming (GFM) mode to the other of the GFL mode and the GFM mode; and output a signal to cause the first portion of inverters to change from of the GFL mode and the GFM mode to the other of the GFL mode and the GFM mode.

In any of the embodiments disclosed herein, the system can further include a controller. The controller can be configured to change the current operating mode for at least one inverter. The instructions, when executed by the one or more processors can further cause the controller to receive the signal and change, via the controller, the current operating mode for the at least a first portion of inverters of the first site.

In any of the embodiments disclosed herein, determining the first portion of inverters of the first site to change the current operating mode can include determining the first portion of inverters to change the current operating mode from GFL mode to GFM mode.

In any of the embodiments disclosed herein, the instructions, when executed by the one or more processors, can further cause the one or more processors to determine, after outputting the signal, whether the first site is still associated with the high-risk condition.

In any of the embodiments disclosed herein, the instructions, when executed by the one or more processors, can further cause the one or more processor to determine, if the first site is not still associated with the high-risk condition, a second portion of inverters of the first site to change from GFM mode to GFL mode.

In any of the embodiments disclosed herein, monitoring sites within the electric grid can include monitoring a number of generators in service within the electric grid. Monitoring sites within the electric grid can further include monitoring a total generation from inverter-based resources within the electric grid.

In any of the embodiments disclosed herein, identifying the first site in the plurality of sites to be associated with the high-risk condition can be based at least in part on a risk score of the number of generators in service within the electric grid to the total generation from inverter-based resources within the electric grid.

An exemplary embodiment of the present disclosure provides a method. The method can include identifying a high-risk site of a plurality of sites within an electric grid. The method can include determining a portion of inverters of the high-risk site to change a current operating mode of the portion of inverters. The method can include changing the current operating mode for the portion of inverters.

In any of the embodiments disclosed herein, identifying the high-risk site of the plurality of sites within the electric grid can include monitoring a number of generators in service at the plurality of sites. Identifying the high-risk site of the plurality of sites within the electric grid can further include monitoring a total generation from inverter-based resources. Identifying the high-risk site of the plurality of sites within the electric grid can further include determining whether a site of the plurality of sites is a high-risk site based at least in part on a ration of the number of generators in service to the total generation from inverter-based resources.

In any of the embodiments disclosed herein, the current operating mode can be selected from a group consisting of Grid-Following (GFL) mode and Grid-Forming (GFM) mode.

In any of the embodiments disclosed herein, changing the current operating mode for the portion of inverters can include changing the current operating ode from GFL mode to GFM mode for the portion of inverters.

In any of the embodiments disclosed herein, the method can further include monitoring, after changing the current operating mode for the portion of inverters, whether risk conditions of the high-risk site have been reduced.

In any of the embodiments disclosed herein, the method can further include changing, if the risk conditions of the high-risk site have been reduced, at least a portion of inverters from GFM mode to GFL mode.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates an example system for configuring inverter-based resources to mitigate high-risk conditions, in accordance with examples of the disclosed technology.

FIG. 2 illustrates an example computing device configured to mitigate high-risk conditions via inverter-based resources, in accordance with examples of the disclosed technology.

FIG. 3 is a flow diagram illustrating an exemplary method of configuring inverter-based resources to mitigate high-risk conditions, in accordance with examples of the disclosed technology.

FIG. 4 is another flow diagram illustrating an exemplary method of configuring inverter-based resources to mitigate high-risk conditions, in accordance with examples of the disclosed technology.

FIG. 5. is yet another flow diagram illustrating an exemplary method of configuring inverter-based resources to mitigate high-risk conditions, in accordance with examples of the disclosed technology.

FIG. 6 is yet another flow diagram illustrating an exemplary method of configuring inverter-based resources to mitigate high-risk conditions, in accordance with examples of the disclosed technology.

### DETAILED DESCRIPTION

Renewable energy generation sites (e.g., solar photovoltaic arrays) and battery storage systems (e.g., battery energy storage systems, or BESS) can require a conversion of direct current (DC) power output to alternating current (AC) power usable in the electric grid. Inverters, as will be discussed in greater detail herein, can enable the conversion of power from one of AC and DC to the other. Some inverters operate in grid-following (GFL) mode, where they are configured to inject current in response to measured voltage and/or frequency levels of the grid. Other inverters can operate in grid-forming (GFM) mode, which can include an internal reference signal that allows an inverter in GFM mode to inject voltage instantaneously in the event of a fault. GFL mode inverters can be less effective at responding to a fault, whereas GFM mode inverters can be limited by requiring operation below capacity to enable response to faults. Some inverters can switch between GFM mode and GFL mode. The disclosed technology includes systems and methods for mitigating high-risk conditions for the electric grid based on these principles. The disclosed technology can include a method including monitoring a plurality of sites within the electric grid. The method can include identifying a first site of the plurality of sites to be associated with a high-risk condition. The method can include determining a first portion of inverters of the first site to change a current operating mode of the first portion of inverters from one of the GFL mode and the GFM mode to the other of the GFL mode and the GFM mode. The method can include outputting a signal to cause the first portion of inverters to change from the one of the GFL mode and the GFM mode to the other of the GFL mode and the GFM mode.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of being systems and methods for avoiding basis risk for energy generation sites. The present disclosure, however, is not so limited, and can be applicable in other contexts in which data is provided by a human and entered into a computing system. For example, the disclosed technology can be applicable to systems in which a human can enter data via a keyboard, a mouse, a microphone (e.g., interactive voice response (IVR)), or other devices configured to provide data from a human to a computing system. Accordingly, when the present disclosure is described in the context of systems and methods for basis avoidance for energy generation sites, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

As used herein, the term “energy generation site” or “site” can include any location or plant that would be considered by one of ordinary skill in the art to be a source of power, energy, electricity, or any combination thereof for the electric grid. As non-limiting examples, energy generation sites can include renewable energy sites and non-renewable energy sites, such as wind, solar, hydroelectric, battery storage, nuclear, natural gas, coal-fired, geothermal, biomass, and hydrogen plants.

As used herein, the term “inverter” can include any device that would be considered by one of ordinary skill in the art to be able to convert direct current (DC) power to alternating current (AC) power or to convert AC power to DC power. As non-limiting examples, inverters can have the ability to synchronize an output voltage and frequency with an electric grid voltage and electric grid frequency, and maintain output voltages of energy generation sites to prevent output voltages outside of acceptable limits.

Similarly, an “inverter-based resource” can include any power generation site, project, plant, or location which utilizes an invert to connect to the electric grid. As non-limiting examples, inverter-based resources can include any examples of energy generation sites discussed herein.

As used herein, the term “current operating mode” or “inverter mode” can include any mode for an inverter that defines the operation of the inverter with respect to its management of the flow of electrical power. The current operating mode can define how the inverter interacts with an electric grid, and specifically can determine how the inverter manages the voltage and/or frequency of the power flowing through the inverter. As non-limiting examples, the current operating mode can include grid-forming mode, grid-following mode, and any similar operating mode for an inverter relating to the control of electric current from the inverter.

As used herein, the term “grid-forming” or “grid-forming mode” can include an operating mode for an inverter considered by one of skill in the art to be able to use an internal generated voltage signal as a reference for control. As non-limiting examples, grid-forming (GFM) mode can include a current operating mode for an inverter that may be used as a stand-alone voltage reference for connected electrical components/equipment, and may configure the inverter to be able to respond instantaneously to changes in grid conditions and provide the electric grid with support in the event of a fault.

As used herein, the term “grid-following” or “grid-following mode” can include an operating mode for an inverter considered by one of skill in the art to be able to use external measurements to determine appropriate output voltage and/or frequency for the inverter. As non-limiting examples, grid-following (GFL) mode for an inverter can include a current operating mode that attempts to match output voltage and/or frequency for the inverter with that of the electric grid, and may rely on external commands to change setpoints for real and reactive power output.

Reference will now be made in detail to example embodiments of the disclosed technology that are illustrated in the accompanying drawings and disclosed herein. Wherever convenient, the same reference numbers will be used throughout the drawings to refer to the same or like parts.

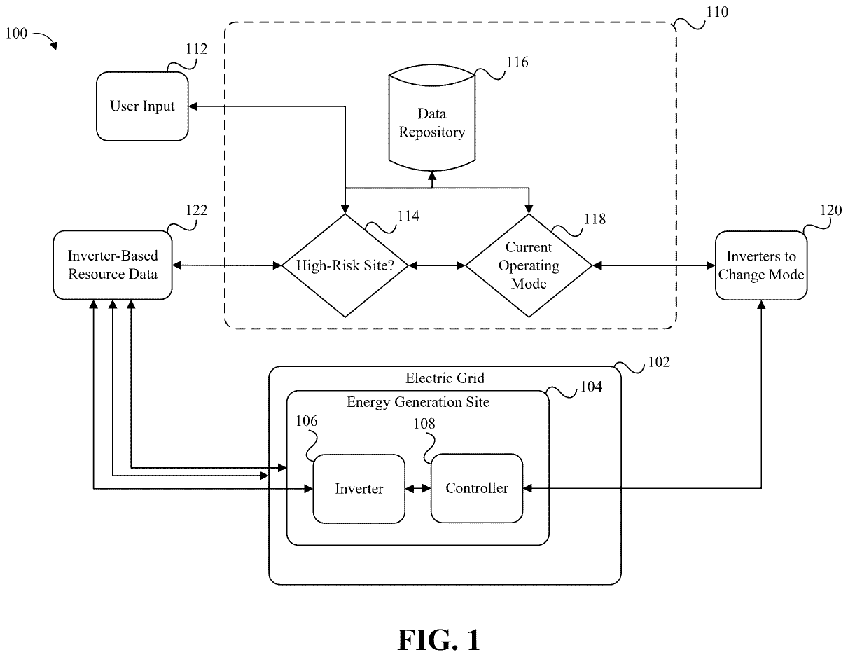

FIG. 1 illustrates an example system 100 for configuring inverter-based resources to mitigate high-risk conditions. One of skill in the art will appreciate that the various features of the system 100 described herein can be incorporated into a single computing device or be divided into distinct parts across a network of computing devices. Thus, although the various features of the system 100 may be described as separate and distinct features or components, the described technology is not so limited.

The system 100 can include an electric grid 102. The electric grid 102 can be defined as is understood in the art. For example, the electric grid 102 can be at least a portion of an interconnected network of energy generation sites. In some embodiments, the electric grid 102 can include an independent system operator (ISO) region, a regional transmission organization (RTO) region, transmission system operator (TSO) region, or any region defined by a grid operator or transmission authority as understood herein. Stated otherwise, the electric grid can include a region under authority of a transmission provider. The electric grid 102, as can be appreciated, can include an energy generation site 104. The energy generation site 104 can be a part of a plurality of energy generation sites within the electric grid 102. That is, the electric grid 102 can include a plurality of energy generation sites. As will be appreciated, a plurality of energy generation sites may be referred to as a plurality of sites herein. In some embodiments, the energy generation site 104 can be a renewable energy site. For example, the energy generation site can include a solar, wind, geothermal, hydropower, bioenergy, biomass, hydrogen, ocean, or any other form of renewable energy generation known in the art. Further, the energy generation site 104 can include a battery storage, or battery energy storage system (BESS). In other example embodiments, the energy generation site 104 can include any non-renewable energy generation, such as coal, oil, or nuclear energy.

The energy generation site 104 can include an inverter 106. As can be appreciated, the inverter 106 can be a part of one or more inverters. That is, the energy generation site 104 can include at least one inverter 106. The inverter 106 may be part of a plurality of inverters. In this way, the energy generation site can include multiple of the inverter 106. As defined previously herein, the inverter 106 can be configured to convert power generated via the energy generation site 104 from one current type to another current type. In some embodiments, the inverter 106 can be configured to convert electric power from DC power to AC power. In this way, the inverter 106 can be configured to convert power generated by a renewable energy site into power usable to the electric grid 102. The inverter 106 can operate based at least in part on a current operating mode of the inverter 106. That is, the inverter 106 can be configured to be changed between one or more current operating modes of the inverter 106. As will be discussed in greater detail herein, the current operating mode can be one of a Grid-Following (GFL) mode and a Grid-Forming (GFM) mode. That is, the inverter 106 can be configured to be in GFL mode. The inverter 106 can be further configured to be in GFM mode. That is, in some embodiments, the inverter 106 can be configured to be changed from GFL mode to GFM mode. Further, in some embodiments, the inverter 106 can be configured to be changed from GFM mode to GFL mode. The inverter 106 can be configured to be manually switched from one current operating mode to another current operating mode. The inverter 106 can be configured to be change current inverter mode based at least in part on a remote signal. For example, the energy generation site 104 can further include a controller 108 in communication with the inverter 106. As will be discussed in greater detail herein, the controller 108 can be configured to change the current operating mode for the inverter 106.

The system 100 can be configured to monitor the electric grid 102. Stated otherwise, the system 100 can be configured to monitor inverter-based resource data 122 of the electric grid 102. In some examples, the system 100 can be configured to monitor inverter-based resource data 122 of the energy generation site 104. As can be appreciated, the system 100 can be configured to monitor inverter-based resource data 122 of the inverter 106. That is, the inverter-based resource data 122 can be based at least in part on the inverter 106. In some embodiments, the inverter-based resource data 122 can be representative of all inverters of the energy generation site 104. The inverter-based resource data 122 can include a number of generators operating within the electric grid 102, a number of generators in service within the electric grid 102, a number of inverters operating within the electric grid 102, a number of generators operating within the energy generation site 104, a total generation from inverter-based resources within the electric grid 102, a total generation from inverter-based resources within the energy generation site 104, a total generation from the inverter 106, a number of inverters in GFL mode in the electric grid 102, a number of inverters in GFM mode in the electric grid 102, a number of inverters in GFL mode in the energy generation site 104, a number of inverters in GFM mode in the energy generation site 104, whether the inverter 106 is in GFL mode or GFM mode, configuration of electrical transmission system, current voltage/frequency conditions, spinning/non-spinning reserve capacity, demand management system capacity, load forecasts, generation forecasts, expected transmission/distribution system outages, expected generating resource outages, expected solar generation resources, temperature forecasts, or any combination thereof. That is, the system 100 can be configured to monitor any of the aforementioned examples of inverter-based resource data of the inverter-based resource data 122, or any further examples of inverter-based resource data discussed herein.

The inverter-based resource data 122, in some embodiments, can include per-inverter active/reactive power reductions for operating in GFM mode or GFL mode. In some embodiments, the inverter-based resource data 122 can include a magnitude of electric system stability risk. The magnitude of electric system stability risk can be determined, in some cases, based on an inverter-based resource generation compared to a spinning generation. In some embodiments, the inverter-based resource data 122 can include a location of GFM capable inverters (inverters able to switch between GFM mode and GFL mode). In some embodiments, the inverter-based resource data 122 can include a state of charge of one or more batteries connected to GFM capable inverters. In some embodiments, the inverter-based resource data 122 can include an expected generation at generation sites with GFM capable inverters. In some embodiments, the inverter-based resource data 122 can include current output setpoints and/or curtailments on generation/storage sites with GFM capable inverters. In some embodiments, the inverter-based resource data 122 can include forecasted generation and storage site outputs. The forecasted generation and storage site outputs can be based on whether the site is an inverter-based resource or a spinning resource. As can be appreciated, the inverter-based resource data 122 can include a status of inverters of the energy generation site 104, the status indicative of whether capable inverters are in GFM mode or GFL mode. In some embodiments, the inverter-based resource data 122 can include transmission/distribution system configurations, transmission/distribution line congestion limitations, and safety margins from a system operator.

In some embodiments, the inverter-based resource data 122 can include real-time data. That is, the system 100 can be configured to monitor the electric grid 102 in real-time, in that the system 100 can be configured to collect the inverter-based resource data 122 in real-time. As can be appreciated, the system 100 can be configured to collect the inverter-based resource data 122 at predetermined time intervals. In this way, the system 100 can be configured to configure inverter-based resources to mitigate high-risk conditions in real-time, as will be discussed in greater detail herein.

The system 100 can include an application 110. The application 110 can be configured to receive the inverter-based resource data 122. In some examples, the application 110 can be configured to receive the inverter-based resource data 122 in real-time. For example, the application 110 can be configured to receive the inverter-based resource data 122 in predetermined time intervals.

The application 110 can include a high-risk site determination 114. That is, the system 100 can be configured to determine whether an energy generation site is a high-risk site. The high-risk site determination 114 can include determining whether the energy generation site 104 is a high-risk site. In this way, the high-risk site determination 114 can be based at least in part on the inverter-based resource data 122. That is, the high-risk site determination 114 can include identifying the energy generation site 104 to be associated with a high-risk condition. The high-risk condition can be a characteristic associated with an energy generation site characterized as a high-risk site such as a potential for fault, a potential for outage, a potential for voltage spike, a potential for current spike, availability of reserve generation, demand management capacity, potential for voltage sags, potential for frequency deviations, potential for oscillations in voltage, potential for oscillations in frequency, or any combination thereof.

The high-risk site determination 114, in some embodiments, can be based at least in part on a risk score threshold. That is, the energy generation site 104 can be identified as a high-risk site, or associated with a high-risk condition, if a risk score based at least in part on the inverter-based resource data 122 is above or below the risk score threshold. The risk score can be determined based at least in part on a number of generators in service within the electric grid, a total generation from inverter-based resources within the electric grid, a number of generators in service within the region, a total generation from inverter-based resources within the region, a total generation from inverter-based resources of the energy generation site 104, a number of generators in service and connected to the energy generation site 104, geographical adjustments based on local available fault current, a system impedance, or any combination thereof. In some embodiments, the high-risk site determination 114 can be based at least in part on a ratio. That is, the risk score can include a ratio. In some embodiments, the risk score can be a ratio of the number of generators in service within the electric grid 102 to the total generation from inverter-based resources within the electric grid 102. That is, if the ratio of the number of generators in service within the electric grid 102 to the total generation from inverter-based resources from the energy generation site 104 is above a predetermined risk score threshold, the energy generation site 104 can be identified as a high-risk site, or to be associated with a high-risk condition, by the high-risk site determination 114. Alternatively, in some embodiments, the energy generation site 104 can be identified as a high-risk site if the risk score is below the predetermined risk score threshold.

The application 110 can include an inverter current operating mode determination 118. The inverter current operating mode determination 118 can include determining a number of inverters of the electric grid 102 to change the current operating mode, such that the system 100 can be configured to determine a number of inverters to change the current operating mode. The inverter current operating mode determination 118 can include determining at least a portion of inverters to change the current operating mode of the energy generation site 104. Similarly, the inverter current operating mode determination 118 can include determining whether the inverter 106 should change the current operating mode. The inverter current operating mode determination 118 can be based at least in part on the inverter-based resource data 122. Further, the inverter current operating mode determination 118 can be based at least in part on the high-risk site determination 114. As can be appreciated, the inverter current operating mode determination 118 can suggest no inverters to change the current operating mode if the high-risk site determination 114 results in a determination that the energy generation site 104 is not a high-risk site, or is not associated with a high-risk condition. Similarly, the inverter current operating mode determination 118 can output a non-zero value of inverters to change the current operating mode if the high-risk site determination 114 results in a determination that the energy generation site 104 is a high-risk site, or is associated with a high-risk condition. In this way, the inverter current operating mode determination 118 can be executed based at least in part on a result of the high-risk site determination 114. Additionally, the inverter current operating mode determination 118 can be conditionally executed based at least in part on the result of the high-risk site determination 114.

The inverter current operating mode determination 118 can be configured to determine a portion of inverters to change mode 120. That is, the inverter current operating mode determination 118 can be configured to produce an output of a portion of inverters to change mode 120. In this way, the application 110 can be configured to determine a portion of inverters to change mode 120 based at least in part on the inverter-based resource data 122. The portion of inverters to change mode 120 can include a portion of inverters of the energy generation site 104 to change the current operating mode. In some embodiments, the portion of inverters to change mode 120 can include determining whether the inverter 106 is needed to change the current operating mode. As can be appreciated, the portion of inverters to change mode 120 can include one or more inverters of the energy generation site 104 to change the current operating mode. The portion of inverters to change mode 120 can include a number of inverters to change the current operating mode. That is, the portion of inverters to change mode 120 can include a number of inverters of the one or more inverters of the energy generation site 104 to change the current operating mode. In some embodiments, the portion of inverters to change mode 120 can include a portion of inverters to change the current operating mode within the electric grid 102. In this way, the portion of inverters to change mode 120 can include a number of inverters to change the current operating mode at one or more energy generation sites in the electric grid 102. Stated otherwise, the portion of inverters to change mode 120 can include data indicative of which inverters are needed to change the current operating mode, how many inverters are needed to change the current operating mode, which energy generation site or energy generation sites the portion of inverters are located, which current operating mode the portion of inverters are currently in, which current operating mode to switch the portion of inverters to, or any combination thereof. In some embodiments, the portion of inverters to change mode 120 can include a number of GFM capable inverters to operate in GFM mode.

In some embodiments, the portion of inverters to change mode 120 can be a first portion of inverters to change the current operating mode. That is, the application 110 can be configured to determine at least a first portion of inverters to change the current operating mode. In some embodiments, the portion of inverters to change mode 120 can include a first portion of inverters of a first site to change the current operating mode and a second portion of inverters to change the current operating mode at a second site, in that the first site and the second site are energy generation sites of the electric grid 102. In this way, the application 110 can be configured to determine at least a first portion of inverters of a first site to change the current operating mode. In some embodiments, the portion of inverters to change mode 120 can include a number of inverters to change the current operating mode for each energy generation site within at least a portion of the electric grid 102. That is, the portion of inverters to change mode 120 can include a plurality of inverters of a plurality of energy generation sites to change the current operating mode.

The portion of inverters to change mode 120 can include a portion of inverters to change the current operating mode from one of GFL mode and GFM mode to the other of the GFL mode and the GFM mode. In some embodiments, the portion of inverters to change mode 120 can include a number of inverters to change from GFL mode to GFM mode. Alternatively, the portion of inverters to change mode 120 can include a number of inverters to change from GFM mode to GFL mode. Further, the portion of inverters to change mode 120 can include a portion of inverters to change the current operating mode from GFM mode to GFL mode and a portion of inverters to change the current operating mode from GFL mode to GFM mode.

As can be appreciated, some inverters of the electric grid 102 may not be configured to change a current operating mode. Considering this, the application 110 can be configured to turn on and turn off one or more inverters of the one or more energy generation sites of the electric grid 102. In this way, the portion of inverters to change mode 120 can include a portion of inverters to turn on. Further, the portion of inverters to change mode 120 can include a portion of inverters to turn off. Similarly, the portion of inverters to change mode 120 can include a portion of inverters to turn on, and portion of inverters to turn off, and a portion of inverters to change the current operating mode. The portion of inverters to turn on and the portion of inverters to turn off can be based at least in part on the respective current operating mode.

The application 110 can be configured to send a signal to a controller 108. That is, the system 100 can be configured to output a signal to the controller 108. The signal can include any form of telemetry command understood for similar contexts by those skilled in the art. That is, the signal can include a telemetry command to a site management system of the electric generation site 104, the site management system configured to change the current operating mode for GFM capable inverters of the energy generation site 104. Further, the site management system, based on the signal, can determine which GFM capable inverters to change current operating mode. The signal can be configured to cause a number of inverters to change a current operating mode based at least in part on the portion of inverters to change mode 120. That is, the controller 108 can be configured to change a current operating mode of one or more inverters of the electric grid 102, in that the controller 108 can be configured to change a current operating mode of one or more inverters of the energy generation site 104. Further, the controller 108 can be configured to change a current operating mode of the inverter 106. Alternatively, the controller 108 can be configured to change a current operating mode of each inverter of the energy generation site 104 based at least in the portion of inverters to change mode 120. That is, the portion of inverters to change mode 120, as can be appreciated, may indicate which inverters of a plurality of inverters of the energy generation site 104 are to change a current operating mode. In this way, the controller 108 can be configured to change a current operating mode for at least one inverter of the energy generation site 104. The controller 108 can be configured to receive the signal, such that the controller 108 may include a receiver. In this way, the signal can be configured to cause the controller 108 to change a current operating mode for a portion of inverters identified by the portion of inverters to change mode 120. As can be appreciated, the signal can be configured to cause the controller to change a current operating mode for the portion of inverters to change mode 120 from one of the GFL mode and the GFM mode to the other of the GFL mode and the GFM mode. In some embodiments, the signal can cause the controller 108 to change a current operating mode for at least a portion of inverters of the energy generation site 104. In some embodiments, the signal can cause the controller 108 to change a current operating mode of a first portion of inverters at a first energy generation site and a second portion of inverters at a second energy generation site. Stated otherwise, the signal can cause the controller 108 to change a current operating mode for one or more inverters at each of a plurality of energy generation sites. As can be appreciated, the signal can cause the controller 108 to change a current operating mode for any number or portion of inverters based at least in part on any embodiments of the portion of inverters to change mode 120 discussed herein.

Although not shown, the application 110 can be further configured to output dispatch commands to curtail other inverter-based resources. In some embodiments, the other inverter-based resources being curtailed do not include GFM capable inverters. Additionally, the dispatch commands can be communicated to start or ramp up generation of spinning resources.

The application 110 can include a data repository 116 configured to store, at least temporarily, data related to configuring inverter-based resources to mitigate high-risk conditions. That is, the system 100 can be configured to store (at least temporarily) data related to determinations of the system 100. For example, the data repository 116 can be configured to store data associated with the electric grid 102, such as transmission provider regions, grid operator regions, ISO/RTO regions, ISO/RTO regulations, energy generations site locations, energy generation site loads, energy generation site capacities, renewable energy site locations, renewable energy site loads, renewable energy site capacities, configuration of electrical transmission system, current voltage/frequency conditions, spinning/non-spinning reserve capacity, demand management system capacity, load forecasts, generation forecasts, expected transmission/distribution system outages, expected generating resource outages, expected solar generation resources, temperature forecasts, or any combination thereof. The data repository 116 can be configured to store the inverter-based resource data 122. The data repository 116 can be configured to store the high-risk site determination 114. That is, the data repository 116 can be configured to store any outputs of the high-risk site determination 114 discussed herein. Further, the data repository 116 can be configured to store the inverter current operating mode determination 118. That is, the data repository 116 can be configured to store any outputs of the inverter current operating mode determination 118 discussed herein.

The application 110 can be configured to receive a user input 112, in that the system 100 can be configured to receive the user input 112. In some embodiments, the high-risk site determination 114 can be based at least in part on the user input 112. That is, the user input 112 can include one or more parameters, values, filters, or elements of similar contexts, which may be input into the application 110 to affect a determination of a high-risk site or high-risk condition. In some embodiments, the inverter current operating mode determination 118 can be based at least in part on the user input 112. That is, the user input 112 can include parameters, values, filters, or elements of similar contexts, which may be input into the application to affect a determination of which inverters are to change a current operating mode. In some embodiments, the user input 112 can include parameters based at least in part on regulations associated with the energy generation site 104. For example, the user input 112 can include data associated with a transmission provider, a grid operator region, such as an ISO or RTO, and associated thresholds related to inverter-based resource generation. In some embodiments, thresholds may include upper bound and lower bound values for active inverters, inverters per current operating mode, total generation from inverter-based resources, load per inverter, capacity per inverter, or any combination thereof.

The system 100 can include an application that can be in communication with the user interface and a machine learning model. As non-limiting examples, the application can be an extension of a browser, a software program, a program or feature of a kernel of the system, or any computer application that can perform the functions described herein.

As will be appreciated, as the machine learning model is trained and becomes more accurate over time, the amount of frequency of user inputs of the user input 112 can be reduced. In other words, as the machine learning model becomes more accurate over time, the need for human oversight of the machine learning model can decrease and the machine learning model can operate largely unsupervised.

The machine learning model can be or include a neural network, a recurrent neural network, a Long Short-Term Memory (LSTM) network, a bi-direction LSTM network, a Conditional Random Fields (CRF) network, an LSTM-CRF network, a Bi-LSTM-CRF network, or other suitable machine learning models. In some embodiments, the machine learning model can employ a gradient boosting model, a light gradient boosting model, or similar models known in the art.

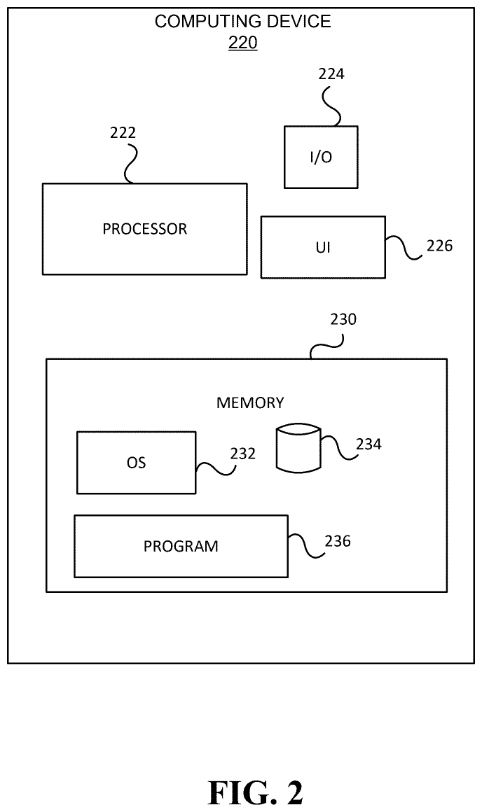

FIG. 2 illustrates an example computing device configured to mitigate high-risk conditions for an electric grid, in accordance with examples of the disclosed technology. As will be appreciated by one of skill in the art, the computing device 220 can be configured to include all or some of the features described in relation to the system 100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In some embodiments, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In some embodiments, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can include the data repository 116.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 (e.g., user interface) for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O devices 224 may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

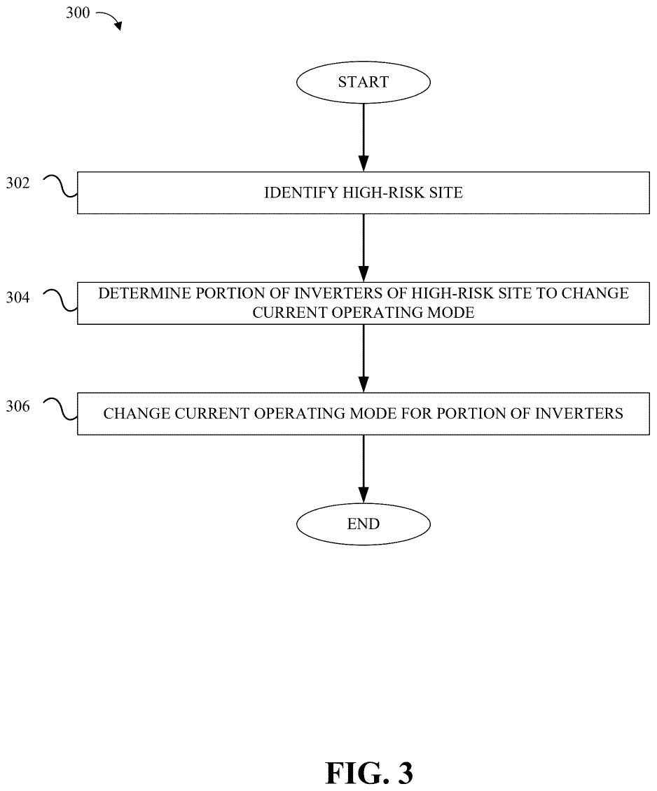

FIG. 3 is a flow diagram illustrating a method 300 for configuring inverter-based resources to mitigate high-risk conditions. The method 300 can include identifying 302 a high-risk site. As can be appreciated, identifying 302 the high-risk site can include monitoring the electric grid. As discussed herein, monitoring the electric grid can include monitoring a plurality of sites, such that the plurality of sites may include the high-risk site. Stated otherwise, identifying 302 the high-risk site can include identifying a site to be associated with a high-risk condition. As understood herein, a high-risk site can be considered an energy generation site associated with a high-risk condition. Monitoring the electric grid, as discussed herein, can include monitoring inverter-based resource data of one or more energy generation sites of the electric grid. Inverter-based resource data can be understood by examples discussed herein, such as, a number of generators in service and a total generation from inverter-based resources. As can be appreciated, the high-risk site can be identified by determining whether a site of the plurality of sites is high-risk, or associated with a high-risk condition. That is, a site can be determined to be a high-risk site based at least in part on the inverter-based resource data of the site. For example, a site can be determined to be a high-risk site if a ratio (e.g., a risk score) of the number of generators in service to the total generation from inverter-based resources is above/below a predetermined threshold. As can be appreciated, the predetermined threshold can be set by the user. In other embodiments, the predetermined threshold can be automatically generated based at least in part on historical inverter-based resource data.

The method 300 can include determining 304 a portion of inverters of the high-risk site to change a current operating mode. As discussed herein, the portion of inverters of the high-risk site to change the current operating mode can include a number of inverters of the high-risk site to change the current operating mode and which current operating mode for each of the portion of inverters to change to. For example, determining 304 the portion of inverters of the high-risk site to change the current operating mode can include determining a value for a number of inverters of the high-risk site to change the current operating mode. The value for the number of inverters of the high-risk site to change the current operating mode can be determined based at least in part on a number of inverters of the high-risk site in GFL mode and a number of inverters of the high-risk site in GFM mode. In some embodiments, the value for the number of inverters of the high-risk site to change the current operating mode can be further based on a risk value of the high-risk condition, in that a magnitude of the risk value can be indicative of a risk level of the high-risk condition. In this way, the value for the number of inverters of the high-risk site to change the current operating mode can be calculated based at least in part on the risk value. As can be appreciated, the portion of inverters of the high-risk site to change current operating mode can be determined based at least in part on the inverter-based resource data of the high-risk site.

In some embodiments, the portion of inverters of the high-risk site to change the current operating mode can be determined based at least in part on an amount of voltage support needed to mitigate stability issues of a region. That is, the high-risk site can be part of a plurality of high-risk sites of the region, such that the high-risk site can be one of multiple sites of the plurality of high-risk sites that include GFM capable inverters. The amount of voltage support can be based on a contribution of GFM capable inverters and/or GFM capable inverter-based resources at high-risk sites of the region. In this way, the portion of inverters of the high-risk site to change the current operating mode can be determined based on real-time inputs, as discussed herein, by identifying a proximity of the high-risk site, or the plurality of high-risk sites of the region, to a stability issue (e.g., high risk condition). The proximity to the stability issue can be identified by comparing the real-time inputs (including any examples of real-time inverter-based resource data discussed herein) to the amount of voltage support needed to mitigate stability issues. In some embodiments, the portion of inverters of the high-risk site to change the current operating mode can be determined further based on margins of safety of the high-risk site.

In some embodiments, the current operating mode can be selected from a group consisting of GFL mode and GFM mode. In this way, determining 304 the portion of inverters of the high-risk site to change current operating mode can include determining a portion of inverters to change from one of GFL mode and GFM mode to the other of GFL mode and GFM mode. Similarly, in some embodiments, determining 304 the portion of inverters of the high-risk site to change the current operating mode can include determining a portion of inverters to change from GFL mode to GFM mode and a portion of inverters to change from GFM mode to GFL mode. As can be appreciated, whether the portion of inverters includes the portion of inverters to change from GFM mode to GFL mode, the portion of inverters to change from GFL mode to GFM mode, or both, can be based at least in part on whether the high-risk site has been previously identified as a high-risk site, or whether risk conditions of the high-risk site have been reduced.

The method 300 can include changing 306 the current operating mode for the portion of inverters. Changing 306 the current operating mode for the portion of inverters can include receiving a signal, including the portion of inverters, at a controller of the high-risk site. In some embodiments, changing 306 the current operating mode for the portion of inverters can include changing the current operating mode from GFL mode to GFM mode for the portion of inverters. The portion of inverters can be changed from GFL mode to GFM mode based on the presence of the high-risk condition at the high-risk site, such that changing 306 the portion of inverters from GFL mode to GFM mode can cause risk conditions of the high-risk site to be reduced. As will be discussed in greater detail herein, after it is determined that risk conditions of the high-risk site have been reduced, or that the site is no longer a high-risk site, a portion of inverters can be changed from GFM mode to GFL mode.

Although not shown, the method 300 can include outputting dispatch commands to curtail generation at other inverter-based resources and ramp-up generation of traditional generation resources. As discussed herein, the other inverter-based resources can include generation sites that do not include GFM capable inverters. Additionally, the traditional generation resources can include any embodiments of spinning resources and spinning generation resources discussed herein. Dispatch commands can include any embodiments of signals or telemetry commands discussed herein, such that the dispatch commands can be communicated to management systems and/or site controllers of the other inverter-based resources and the traditional generation resources.

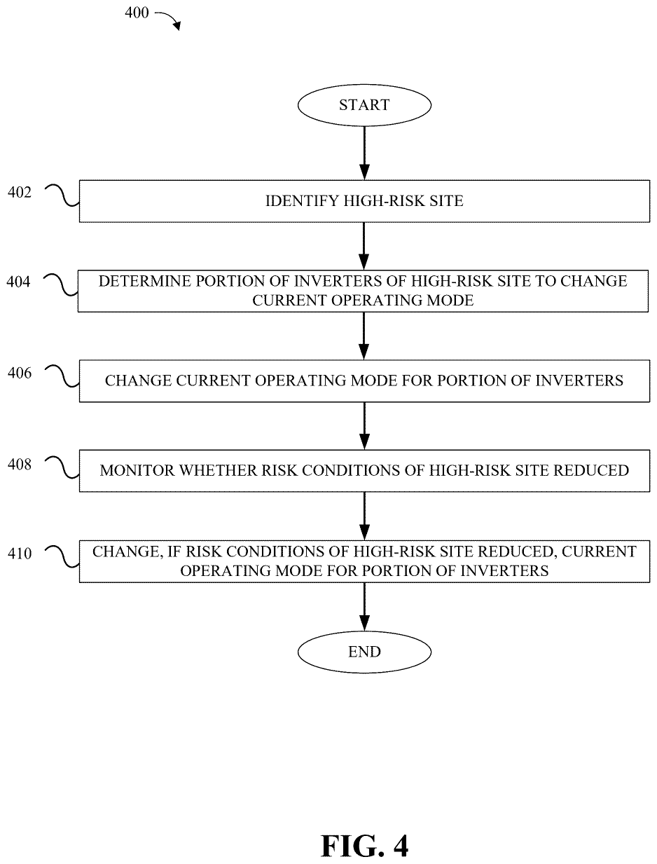

FIG. 4 is another flow diagram illustrating an exemplary method 400 for configuring inverter-based resources to mitigate high-risk conditions. As before, the method 400 can include identifying 402 a high-risk site. As before, the method 400 can include determining 404 a portion of inverters of the high-risk site to change a current operating mode. Additionally, the method 400 can include monitoring 408 whether risk conditions of the high-risk site are reduced. As can be appreciated, monitoring 408 whether risk conditions of the high-risk site are reduced can include determining, after a predetermined duration of time, whether the high-risk site is still a high-risk site. Stated otherwise, determining whether the high-risk site is still a high-risk site can include determining, after the predetermined duration of time, whether the high-risk site is still considered to be associated with the high-risk condition. In this way, monitoring 408 whether risk conditions of the high-risk site are, or have been, reduced can include executing a second iteration, after the predetermined duration of time, of any method or algorithm for determining a high-risk site discussed herein. Alternatively, monitoring 408 whether risk conditions of the high-risk site have been reduced can be part of monitoring real-time inverter-based resource data at predetermined regular time intervals and determining, at the predetermined regular time intervals, whether a site of the plurality of sites is considered a high-risk site. In this way, whether risk conditions of the high-risk site have been reduced can be monitored via any embodiments of monitoring the inverter-based resource data discussed herein.

The method can include changing 410, if risk conditions of the high-risk site are reduced, a current operating mode for a portion of inverters. As can be appreciated, if risk conditions of the high-risk site are reduced, the high-risk site may no longer be considered a high-risk site. In this way, if risk conditions of the high-risk site have been reduced, the current operating mode for the portion of inverters can be changed based at least in part on a desire to maximize output of the high-risk site. That is, changing 410, if risk conditions of the high-risk site are reduced, the current operating mode for the portion of inverters can include restoring, at least in part, a desired output of the high-risk site. Restoring the desired output, at least in part, of an energy generation site (e.g., the high-risk site) can include changing one or more inverters from GFM mode to GFL mode, such that GFM mode is characterized as having a reduced output potential compared to GFL mode. In this way, the portion of inverters to change the current operating mode, if risk conditions of the high-risk site have been reduced, can include one or more inverters of the high-risk site to change from GFM mode to GFL mode.

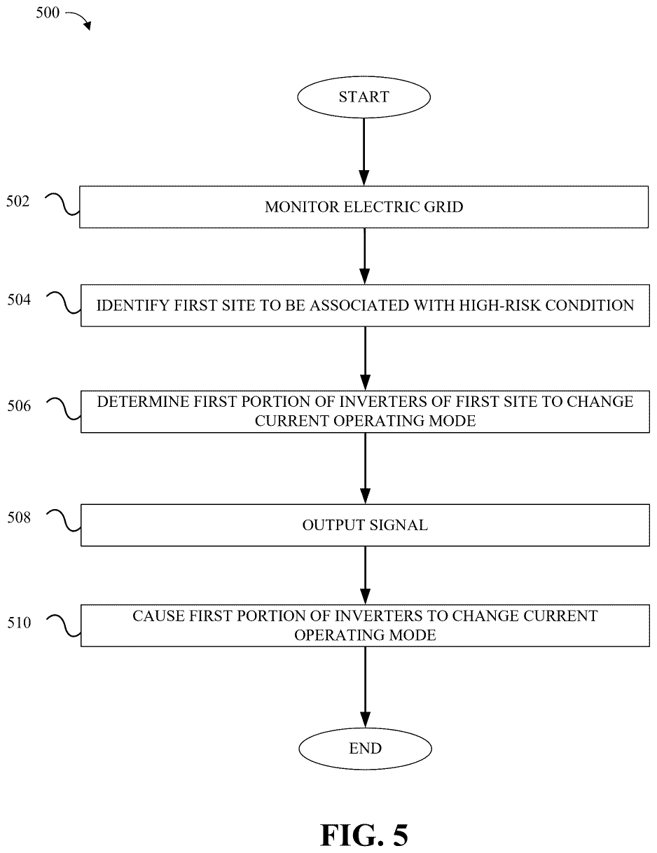

FIG. 5. is yet another flow diagram illustrating an exemplary method 500 for configuring inverter-based resources to mitigate high-risk conditions. The method 500 can include monitoring 502 the electric grid. Monitoring 502 the electric grid, in some embodiments, can include monitoring a plurality of sites, or plurality of energy generation sites, of the electric grid, as will be discussed in greater detail herein. That is, monitoring 502 the electric grid can include monitoring an energy generation site. In some embodiments, the energy generation site being monitored can be a first site. Monitoring 502 the electric grid can include monitoring inverter-based resource data for the electric grid, as discussed herein. The inverter-based resource data can include any embodiments of inverter-based resource data discussed herein, such that, in some embodiments, the inverter based resource data can include a number of generators in service within the electric grid and a total generation from inverter-based resources within the electric grid. In some embodiments, the inverter-based resource data can be specific to an energy generation site, such that the inverter-based resource data can include a number of inverters in service at an energy generation site, a total generation associated with one or more inverters from the energy generation site, a load for each inverter of the energy generation site, a capacity for each inverter of the energy generation site, a number of generators operating within the energy generation site, a total generation from inverter-based resources within the energy generation site, a number of inverters in GFL mode in the electric grid, a number of inverters in GFM mode in the electric grid, a number of inverters in GFL mode in the energy generation site, a number of inverters in GFM mode in the energy generation site, whether the inverter is in GFL mode or GFM mode, configuration of electrical transmission system, current voltage/frequency conditions, spinning/non-spinning reserve capacity, demand management system capacity, load forecasts, generation forecasts, expected transmission/distribution system outages, expected generating resource outages, expected solar generation resources, temperature forecasts, or any combination thereof. In some embodiments, monitoring an energy generation site can include monitoring risk conditions of energy generation sites connected with the energy generation site. In this way, the electric grid can be monitored based at least in part on collecting data for determining high-risk conditions for energy generation sites within the electric grid.

The method 500 can include identifying 504 a first site to be associated with a high-risk condition. As can be appreciated, the first site can be identified to be associated with a high-risk condition if the first site is considered a high-risk site. The first site can include any embodiments of energy generation site discussed herein. The high-risk condition can include any embodiments of high-risk conditions discussed herein. Further, the first site can be identified as being associated with a high-risk condition based at least in part on inverter-based resource data. Specifically, in some embodiments, the first site can be identified as being associated with a high-risk condition based at least in part on a ratio of the number of generators in service to the total generation from inverter-based resources. In some embodiments, the first site can be identified from a plurality of energy generation sites within the electric grid. Further, the first site can be identified from a plurality of energy generation sites being monitored by the user. That is, identifying 504 the first site to be associated with a high-risk condition can include determining one or more sites that are associated with a high-risk condition based at least in part on data collected while monitoring 502 the electric grid.

In some embodiments, the first site can be part of a plurality of sites within the electric grid, as will be discussed in greater detail herein. In some embodiments, the first site can be a renewable energy site. As discussed herein, the first site can be identified as being associated with a high-risk condition based at least in part on user input, in that the first site can be selected, by a user, as a high-risk site, or as being associated with a high-risk condition, based at least in part on the inverter-based resource data. As will be appreciated, the first site can include at least one inverter. In this way, the first site can include one or more inverter-based resources configured to be monitored.

The method 500 can include determining 506 a first portion of inverters of the first site to change a current operating mode. The first portion of inverters to change the current operating mode can include any number of inverters of the first site. Stated otherwise, the first portion of inverters to change the current operating mode can include any portion of inverters of the first site. The first portion of inverters to change the current operating mode can be determined based at least in part on the inverter-based resource data for the first site, such that the first portion of inverters to change the current operating mode can be determined after monitoring 502 the electric grid.

The method 500 can include outputting 508 a signal. The signal can be output by any computing device including a transmitter, transponder, transceiver, or similar devices as understood herein. The signal can include the first portion of inverters to change the current operating mode, in that the signal can include instructions indicating, to a receiving device, which inverters of one or more inverters of the first site are to change a current operating mode. Further, the signal can include instructions, which, when executed by one or more processors of a system of the first site, may cause the one or more processors to change the current operating mode for the first portion of inverters.

The method 500 can include causing 510 a first portion of inverters to change a current operating mode. As discussed herein, the first portion of inverters can be caused to change a current operating mode based at least in part on the signal. That is, causing 510 the first portion of inverters to change the current operating mode can include receiving the signal and changing the current operating mode for the first portion of inverters. As discussed herein, changing the current operating mode for the first portion of inverters can include changing the current operating mode for the first portion of inverters via a controller. The controller, that is, can be configured to change the current operating mode for at least the first portion of inverters. As discussed herein, the controller can be associated with the first site, in that the controller can be configured to change a current operating mode for each inverter of the first site.

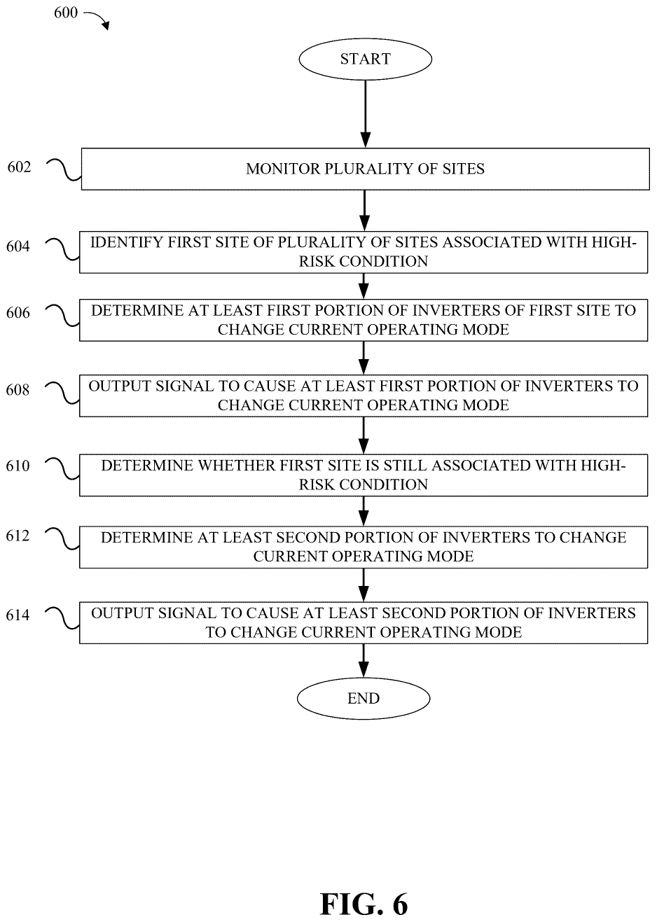

FIG. 6 is yet another flow diagram illustrating an exemplary method 600 for configuring inverter-based resources to mitigate high-risk conditions. The method 600 can include monitoring 602 a plurality of sites. As discussed herein, the plurality of sites can be a plurality of energy generation sites of an electric grid. That is, the method 600 can include any embodiments of the energy generation site 104 and the electric grid 102 discussed herein. Monitoring 602 the plurality of sites can include collecting inverter-based resource data in real-time. The inverter-based resource data can include any embodiments of inverter-based resource data discussed herein. That is, monitoring 602 the plurality of sites can include monitoring any combination of inverters of any number or combination of energy generation sites discussed herein. For example, monitoring 602 the plurality of sites can include monitoring a number of generators in service within an electric grid and monitoring a total generation from inverter-based resources within the electric grid. As can be appreciated, any inverter-based resource data discussed herein can be monitored such that any system for determining a number or portion of inverters to change operating mode may receive real-time inverter-based resource data.

The method 600 can include identifying 604 a first site of a plurality of sites to be associated with a high-risk condition. The first site can include any embodiments of energy generation sites discussed herein, in that, in some embodiments, the first site can be a renewable energy site. As can be appreciated, the first site associated with a high-risk condition can be a high-risk site. The high-risk condition can include any embodiments of high-risk conditions or characterizations of high-risk sites discussed herein. Stated otherwise, an energy generation site, or first site, associated with a high-risk condition can be considered a high-risk site. In some embodiments, the first site associated with a high-risk condition can be identified based at least in part on inverter-based resource data. That is, the first site associated with a high-risk condition can be identified in real-time based on real-time inverter based resource data from monitoring 602 the plurality of sites. In some embodiments, identifying 604 the first site associated with a high-risk condition can include determining whether the first site is a high-risk site. As discussed herein, determining whether the first site is a high-risk site can be based at least in part on a of the number of generators in service within the electric grid and the total generation from inverter-based resources. The total generation from inverter-based resources can include a total generation from inverter-based resources within the first site. In some embodiments, the total generation from inverter-based resources can include a total generation from inverter-based resources within the electric grid. In some embodiments, the first site associated with a high-risk condition can be identified based at least in part on historical data. That is, a site can be determined to be a high-risk site based at least in part on historical data associated with the site. As discussed herein, the first site associated with a high-risk condition can be identified based at least on one or more parameters received via a user input. The user input can include any embodiments of the user input 112 discussed herein.

The method 600 can include determining 606 at least a first portion of inverters of the first site to change a current operating mode. As can be appreciated, determining 606 at least a first portion of inverters of the first site to change a current operating mode can include determining a number of inverters of the first site to change a current operating mode. As discussed herein, changing a current operating mode can include changing from one of GFL mode to GFM mode to the other of GFL mode and GFM mode. In some embodiments, determining the first portion of inverters of the first site to change a current operating mode can include determining a portion of the inverters of the first site to change from GFL mode to GFM mode. That is, in some embodiments, the first portion of inverters can include a number of inverters to change from GFL mode to GFM mode. In this way, the method 600 can be configured to mitigate the high-risk condition, or risk condition, of the first site via changing the first portion of inverters from GFL mode to GFM mode. As previously discussed, changing one or more inverters from GFL mode to GFM mode can remedy a high-risk condition of an energy generation site. The at least first portion of inverters to change a current operating mode can be determined based at least in part on historical data. In some embodiments, the first portion of inverters to change a current operating mode can be based at least in part on previous determinations of portions of inverters to change a current operating mode. In some embodiments, the first portion of inverters to change a current operating mode can be determined based at least in part on real-time data, such that the first portion of inverters to change a current operating mode can be determined based at least in part on a previous time interval of inverter-based resource data of inverter-based resource data monitored at predetermined time intervals.

The method 600 can include outputting 608 a signal to cause at least the first portion of inverters to change a current operating mode. As can be appreciated, the signal can be outputted by any computing device, transmitter, transceiver, or similar devices for transmitting signals. As discussed herein, the signal can cause at least the first portion of inverters to change a current operating mode via transmitting the signal to a controller. The controller can include any embodiments of the controller 108 discussed herein. The controller can be configured to change a current operating mode for one or more inverters for at least the first site. That is, the controller can be configured to change a current operating mode for at least the first portion of inverters.

The method 600 can include determining 610 whether the first site is still associated with a high-risk condition. As can be appreciated, determining 610 whether the first site is still associated with the high-risk condition can include determining whether the first site is still a high-risk site. Additionally, the determining 610 whether the first site is still associated with the high-risk condition can include any embodiments of determining high-risk sites or determining energy generation sites associated with a high-risk condition discussed herein. That is, determining 610 whether the first site is still associated with a high-risk condition can include similar parameters, values, criteria, filters, or similar elements utilized in identifying 604 the first site of a plurality of sites to be associated with the high-risk condition. As can be appreciated, the first site can be determined to still be associated with the high-risk condition after a period, or duration, of time. That is, the first site can be determined to still be associated with the high-risk condition at predetermined time intervals; for example, every 1 minute, 5 minutes, 10 minutes, etc. In this way, the first site can be determined to still be associated with the high-risk condition based at least in part on real-time data, historical data, previous high-risk conditions of the first site, or any combination thereof. As can be appreciated, the first site can be determined to still be associated with the high-risk condition based at least in part on the inverter-based resource data, or any data being monitored by any embodiments of monitoring systems discussed herein.

The method 600 can include determining 612 a least a second portion of inverters to change a current operating mode. As can be appreciated, the second portion of inverters to change a current operating mode can be determined based at least in part on whether the first site is determined to be still associated with a high-risk condition. That is, the second portion of inverters to change a current operating mode can include any portion, or number, of inverters of the first site. In some embodiments, the second portion of inverters can be the same inverters as the first portion of inverters. For example, if the first site is determined to be no longer associated with the high-risk condition, or if risk conditions of the first site have been reduced, then the second portion of inverters to change a current operating mode can include, in some embodiments, the first portion of inverters. In this way, the first portion of inverters of the first site can be changed from GFL mode to GFM mode if the first site is associated with a high-risk condition, and the first portion of inverters can be changed from GFM mode to GFL mode after the first site is determined to be no longer associated with the high-risk condition. In some embodiments, the second portion of inverters to change a current operating mode can include one or more inverters not a part of the first portion of inverters. Stated otherwise, the second portion of inverters to change a current operating mode can include the first portion of inverters to change a current operating mode, a portion thereof, or a new portion of inverters. In this way, the second portion of inverters to change a current operating mode can be determined based at least in part on whether the first site is still associated with the high-risk condition after changing the current operating mode for the first portion of inverters. Further, the second portion of inverters to change the current operating mode can include one or more inverters of the first portion of inverters.

In some embodiments, the second portion of inverters to change a current operating mode can be from at least a second site. That is, one or more inverters of the second portion of inverters to change a current operating mode can be from one or more energy generation sites. In this way, if the first site is determined to be still associated with the high-risk condition, one or more inverters from at least a second site can change a current operating mode in order to mitigate the high-risk condition of the first site. As can be appreciated, energy generation sites, such as the first site and the second site, may be electrically interconnected, allowing changes or alterations to inverter-based resources at one energy generation site affect risk conditions, or the presence thereof, at another energy generation site. Further, the second portion of inverters to change a current operating mode can be determined to change from one of the GFL mode and the GFM mode to the other of the GFL mode and the GFM mode. For example, the second portion of inverters to change a current operating mode can be determined to change from GFL mode to GFM mode. In some embodiments, the second portion of inverters to change a current operating mode can be determined to change from GFM mode to GFL mode. In some embodiments, one or more inverters of the second portion of inverters to change a current operating mode can be determined to change from GFM mode to GFL mode if the first site is determined to be no longer associated with a high-risk condition. In this way, the method 600 can include restoring a desired output potential of the first site, if the first site is no longer associated with a high-risk condition. As can be appreciated, restoring the desired output potential of a first site can include changing the current operating mode for one or more inverters of the first site from GFM mode to GFL mode.

The method 600 can include outputting 614 a signal to cause at least a second portion of inverters to change a current operating mode. As can be appreciated, the signal can be output by any embodiments of signal transmission devices, or transmitters, discussed herein. As discussed herein, the signal can cause the second portion of inverters to change a current operating mode via a controller. The controller can include any embodiments of controller discussed herein. In some embodiments, the same controller can be configured to change a current operating mode for the first portion of inverters and the second portion of inverters. In some embodiments, the controller configured to change a current operating mode for the second portion of inverters can be a different controller from the controller configured to change the current operating mode for the first portion of inverters. As can be appreciated, in some embodiments, each energy generation site can have its own controller. In this way, if the second portion of inverters to change a current operating mode includes one or more inverters from at least a second site, then, in some embodiments, the controller configured to change a current operating mode for the second portion of inverters can include at least a second controller, such that the controller configured to change a current operating mode for the first portion of inverters can be a first controller. Further, the signal, as discussed herein, can be output to multiple controllers, such that if the second portion of inverters includes one or more inverters from multiple energy generation sites, the multiple controllers can be configured to cause the second portion of inverters to change a current operating mode.

The disclosed technology can be further understood according to the following clauses:
Clause 1: A method for mitigating high-risk conditions for an electric grid comprising: monitoring a plurality of sites within an electric grid; identifying a first site of the plurality of sites to be associated with a high-risk condition; determining a first portion of inverters of the first site to change a current operating mode of the first portion of inverters from one of a Grid-Following (GFL) mode and a Grid-Forming (GFM) mode to the other of the GFL mode and the GFM mode; and outputting a signal to cause the a first portion of inverters to change from the one of the GFL mode and the GFM mode to the other of the GFL mode and the GFM mode.
Clause 2: The method of Clause 1, further comprising receiving the signal at a controller and changing, via the controller, the current operating mode for the first portion of inverters of the first site.
Clause 3: The method of Clause 1, wherein determining the first portion of inverters of the first site to change the current operating mode comprises determining the first portion of inverters to change the current operating mode from GFL mode to GFM mode.
Clause 4: The method of Clause 3, further comprising determining, after outputting the signal, whether the first site is still associated with the high-risk condition.
Clause 5: The method of Clause 4, further comprising determining, if the first site is not still associated with the high-risk condition, a second portion of inverters of the first site to change the current operating mode from GFM mode to GFL mode.
Clause 6: The method of Clause 1, wherein monitoring the plurality of sites within the electric grid comprises: monitoring a number of generators in service within the electric grid; and monitoring a total generation from inverter-based resources within the electric grid.
Clause 7: The method of Clause 6, wherein identifying the first site in the plurality of sites to be associated with the high-risk condition is based at least in part on a ratio of the number of generators in service within the electric grid to the total generation from inverter-based resources within the electric grid.
Clause 8: A system comprising: one or more processors; and memory storing instructions that, when executed by the one or more processors, cause the one or more processors to: monitor a plurality of sites within an electric grid; identify a first site in the plurality of sites to be associated with a high-risk condition; determine a first portion of inverters of the first site to change a current operating mode from one of a Grid-Following (GFL) mode and Grid-Forming (GFM) mode to the other of the GFL mode and the GFM mode; and output a signal to cause the first portion of inverters to change from the one of the GFL mode and the GFM mode to the other of the GFL mode and the GFM mode.
Clause 9: The system of Clause 8, further comprising a controller configured to change the current operating mode for at least one inverter, wherein the instructions, when executed by the one or more processors, further cause the controller to receive the signal and change, via the controller, the current operating mode for the at least a first portion of inverters of the first site.
Clause 10: The system of Clause 8, wherein determining the first portion of inverters of the first site to change the current operating mode comprises determining the first portion of inverters to change the current operating mode from GFL mode to GFM mode.
Clause 11: The system of Clause 10, wherein the instructions, when executed by the one or more processors, further cause the one or more processors to determine, after outputting the signal, whether the first site is still associated with the high-risk condition.
Clause 12: The system of Clause 11, wherein the instructions, when executed by the one or more processors, further cause the one or more processors to determine, if the first site is not still associated with the high-risk condition, at least a second portion of inverters of the first site to change from GFM mode to GFL mode.
Clause 13: The system of Clause 8, wherein monitoring sites within the electric grid comprises: monitoring a number of generators in service within the electric grid; and monitoring a total generation from inverter-based resources within the electric grid.
Clause 14: The system of Clause 13, wherein identifying the first site in the plurality of sites to be associated with the high-risk condition is based at least in part on a ratio of the number of generators in service within the electric grid to the total generation from inverter-based resources within the electric grid.
Clause 15: A method comprising: identifying a high-risk site of a plurality of sites within an electric grid; determining a portion of inverters of the high-risk site to change a current operating mode of the portion of inverters; and changing the current operating mode for the portion of inverters.
Clause 16: The method of Clause 15, wherein identifying the high-risk site of the plurality of sites within the electric grid comprises: monitoring a number of generators in service at the plurality of sites; monitoring a total generation from inverter-based resources; and determining whether a site of the plurality of sites is a high-risk site based at least in part on a ratio of the number of generators in service to the total generation from inverter-based resources.
Clause 17: The method of Clause 15, wherein the current operating mode is selected from a group consisting of Grid-Following (GFL) mode and Grid-Forming (GFM) mode.
Clause 18: The method of Clause 17, wherein changing the current operating mode for the portion of inverters comprises changing the current operating mode from GFL mode to GFM mode for the portion of inverters.
Clause 19: The method of Clause 15, further comprising monitoring, after changing the current operating mode for the portion of inverters, whether risk conditions of the high-risk site have been reduced.
Clause 20: The method of Clause 19, further comprising changing, if the risk conditions of the high-risk site have been reduced, at least a portion of inverters from GFM mode to GFL mode.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods, and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method for mitigating high-risk conditions for an electric grid comprising:
monitoring a plurality of sites within an electric grid;
identifying a first site of the plurality of sites to be associated with a high-risk condition;
determining a first portion of inverters of the first site to change a current operating mode of the first portion of inverters from one of a Grid-Following (GFL) mode and a Grid-Forming (GFM) mode to the other of the GFL mode and the GFM mode; and
outputting a signal to cause the first portion of inverters to change from the one of the GFL mode and the GFM mode to the other of the GFL mode and the GFM mode.

2. The method of claim 1, further comprising receiving the signal at a controller and changing, via the controller, the current operating mode for the first portion of inverters of the first site.

3. The method of claim 1, wherein determining the first portion of inverters of the first site to change the current operating mode comprises determining the first portion of inverters to change the current operating mode from GFL mode to GFM mode.

4. The method of claim 3, further comprising determining, after outputting the signal, whether the first site is still associated with the high-risk condition.

5. The method of claim 4, further comprising determining, if the first site is not still associated with the high-risk condition, a second portion of inverters of the first site to change the current operating mode from GFM mode to GFL mode.

6. The method of claim 1, wherein monitoring the plurality of sites within the electric grid comprises:
monitoring a number of generators in service within the electric grid; and
monitoring a total generation from inverter-based resources within the electric grid.

7. The method of claim 6, wherein identifying the first site in the plurality of sites to be associated with the high-risk condition is based at least in part on a ratio of the number of generators in service within the electric grid to the total generation from inverter-based resources within the electric grid.

8. A system comprising:
one or more processors; and
memory storing instructions that, when executed by the one or more processors, cause the one or more processors to:
monitor a plurality of sites within an electric grid;
identify a first site in the plurality of sites to be associated with a high-risk condition;
determine a first portion of inverters of the first site to change a current operating mode from one of a Grid-Following (GFL) mode and Grid-Forming (GFM) mode to the other of the GFL mode and the GFM mode; and
output a signal to cause the first portion of inverters to change from the one of the GFL mode and the GFM mode to the other of the GFL mode and the GFM mode.

9. The system of claim 8, further comprising a controller configured to change the current operating mode for at least one inverter, wherein the instructions, when executed by the one or more processors, further cause the controller to receive the signal and change, via the controller, the current operating mode for the at least a first portion of inverters of the first site.

10. The system of claim 8, wherein determining the first portion of inverters of the first site to change the current operating mode comprises determining the first portion of inverters to change the current operating mode from GFL mode to GFM mode.

11. The system of claim 10, wherein the instructions, when executed by the one or more processors, further cause the one or more processors to determine, after outputting the signal, whether the first site is still associated with the high-risk condition.

12. The system of claim 11, wherein the instructions, when executed by the one or more processors, further cause the one or more processors to determine, if the first site is not still associated with the high-risk condition, at least a second portion of inverters of the first site to change from GFM mode to GFL mode.

13. The system of claim 8, wherein monitoring sites within the electric grid comprises:
monitoring a number of generators in service within the electric grid; and
monitoring a total generation from inverter-based resources within the electric grid.

14. The system of claim 13, wherein identifying the first site in the plurality of sites to be associated with the high-risk condition is based at least in part on a ratio of the number of generators in service within the electric grid to the total generation from inverter-based resources within the electric grid.

15. A method comprising:
identifying a high-risk site of a plurality of sites within an electric grid;
determining a portion of inverters of the high-risk site to change a current operating mode of the portion of inverters; and
changing the current operating mode for the portion of inverters.

16. The method of claim 15, wherein identifying the high-risk site of the plurality of sites within the electric grid comprises:
monitoring a number of generators in service at the plurality of sites;
monitoring a total generation from inverter-based resources; and
determining whether a site of the plurality of sites is a high-risk site based at least in part on a ratio of the number of generators in service to the total generation from inverter-based resources.

17. The method of claim 15, wherein the current operating mode is selected from a group consisting of Grid-Following (GFL) mode and Grid-Forming (GFM) mode.

18. The method of claim 17, wherein changing the current operating mode for the portion of inverters comprises changing the current operating mode from GFL mode to GFM mode for the portion of inverters.

19. The method of claim 15, further comprising monitoring, after changing the current operating mode for the portion of inverters, whether risk conditions of the high-risk site have been reduced.

20. The method of claim 19, further comprising changing, if the risk conditions of the high-risk site have been reduced, at least a portion of the number of inverters from GFM mode to GFL mode.
